(19) United States
(12) Patent Application Publication
(10) Pub. No.: US 2008/0183319 A1
(43) Pub. Date: Jul. 31, 2008

(54) Compressed audio file player

(75) Inventor: Hirofumi Muramatsu, Tokyo (JP)

Correspondence Address: JUNICHI MIMURA;OKI AMERICA INC., 1101 14TH STREET, N.W., SUITE 555, WASHINGTON, DC, 20005, US

(73) Assignee: Oki Electric Industry Co., Ltd.

(21) Appl. No.: 12/003,817

(22) Filed: Jan. 2, 2008

(30) Foreign Application Priority Data
Jan. 30, 2007 (JP) 2007-019043

(51) Int. Cl. G06F 17/00

(52) U.S. Cl. 700/94

(57) ABSTRACT

A compressed audio file player for replaying an audio file including basic data streams in any location includes a size calculator calculating an average size of the basic data streams, a computational circuit calculating a logical location of each basic data stream and a location memory storing location subtraction data, which shows a difference between the relative location and the logical location of each basic data stream and a location finder calculating a location of the audio file to be replayed from the location subtraction data of the basic data stream to be replayed and the logical location of the basic data stream to be replayed, in response to the instruction.

### CROSS-REFERENCE TO RELATED APPLICATION

This application claims the priority benefit of Japanese Patent Application No. 2007-006556, filed Jan. 30, 2007, the entire disclosure of which is incorporated herein by reference.

### BACKGROUND OF THE INVENTION

1. Field of the Invention

The invention relates to an audio player, which can fast-forward or fast-rewind a compressed audio file.

2. Description of the Related Art

There are two major systems for compressing audio data. One is a MP3 (MPEG-1 Audio Layer-3 including MPEG-2 Audio Layer-3 and MPEG-2.5 Audio Layer-3) format and the other is an AAC (Advanced Audio Coding) format. An audio player for compressed audio files, such as MP3 files or AAC files, is required to have functions of fast-forwarding or fast-rewinding in addition to a function of replaying. When the fast-forwarding function or the fast-rewinding function is operated, the compressed audio filed is skipped to a particular location to be played for the next, and the compressed audio filed is replayed from the location.

A MP3 file includes a plurality of frames and headers, each of which is attached to one of the frames at its head. Thus, in order to detect a head of a frame, the compressed audio file is skipped to its desired location initially, and the header is searched from the location. Then, the compressed audio file can be replayed from the head of the frame detected. Under the compressed audio file in the MP3 format, the compressed audio file is replayed from the head of the frame. Thus, it is necessary to find the head of the frame when the compressed audio file is replayed after the fast-forwarding function or the fast-rewinding functioned is performed.

On the other hand, there are two major formats in the AAC formats. One is an ADTS (Audio Data Transport Stream), and the other is an ADIF (Audio Data Interchange Format). As well as the MP3 format, an ADTS file includes a plurality of frames and headers, each of which is attached to one of the frames at its head. Thus, in order to detect a head of a frame, the compressed audio file is skipped to its desired location initially, and the header is searched from the location. Then, the compressed audio file in the ADTS format can be replayed from the head of the frame detected. On the other hand, a compressed audio file in the ADIF includes a herder and frames more than one. Since no header is disposed at each head of one of the frames except for the first frame, it is impossible to skip to the desired location and to search the header from the location for finding the head of the frame.

In order to fast-forward or fast-rewind the compressed audio file compressed in the particular format having no header at the head of each frame, such as the ADIF, some technologies are proposed. One of them is disclosed in the Japanese patent publication reference JP 2002-041095A. The player disclosed in JP 2002-041095A stores location-information of each frame in the compressed audio file wherein the location information is measured from the head of the audio file, and then skips the compressed audio file to the location of the frame stored and replays the compressed audio file from the location. In this type of the player, the locations of all frames of the compressed audio file, which are measured from the head of the compressed audio file, are stored in advance, it is possible to fast-forward and fast-rewind the compressed audio file compressed in the particular format having no header at the head of each frame.

However, the player disclosed in JP 2002-041095A needs a large area for storing the location-information measured from the head of the compressed audio file in its memory. When the location-information of all frames of the compressed audio file is stored, the size of the location-information is the same as that of the compressed audio file. Thus, the half of the memory capacity of the player should be reserved for the location-information of the compressed audio file.

### SUMMARY OF THE INVENTION

An objective of the invention is to solve the above-described problem and to provide an audio player for the compressed audio file in which the location-information of all frames in the compressed audio file for performing a fast-forward function and a fast-rewind function in addition to a replaying function is stored in a relatively small area of the memory.

The objective is achieved by a compressed audio file player for replaying a compressed audio file including a plurality of basic data streams, which includes an instruction circuit sending an instruction of performing either a fast-forwarding or a fast-rewinding for the compressed audio file, a data size calculator calculating an average size of the basic data streams, each of the basic data streams including at least one frame, a computational circuit calculating a logical location of each basic data stream, each logical location being calculated by integrating a number of the basic data stream with the average basic data stream size, a location memory storing location subtraction data, which shows a difference between the relative location and the logical location of each basic data stream, and a location finder calculating a location of the compressed audio file to be replayed from the location subtraction data of the basic data stream to be replayed and the logical location of the basic data stream to be replayed, in response to the instruction.

### BRIEF DESCRIPTION OF THE DRAWINGS

The invention will be more particularly described with reference to the accompanying drawings, in which:

FIG. 1 is a block diagram of a compressed audio player, according to the first embodiment;

FIG. 2 is a location table of basic data streams for the compressed audio player shown in FIG. 1;

FIG. 3 is a block diagram showing a basic structure of a compressed audio file used in the compressed audio player shown in FIG. 1;

FIG. 4 is a flow chart of an operation to calculate a certain playback location of the compressed audio file in the compressed audio player shown in FIG. 1;

FIG. 5 is a block diagram showing a detail structure of a sample compressed audio file used in the compressed audio player shown in FIG. 1;

FIG. 6 is a location table of basic data streams for the compressed audio player in accordance with the block diagram shown in FIG. 5;

FIG. 7 is a block diagram of a compressed audio player, according to the second embodiment;

FIG. 8 is a location table of basic data streams for the compressed audio player shown in FIG. 7;

FIG. 9 is a block diagram showing a basic structure of a compressed audio file used in the compressed audio player shown in FIG. 7;

FIG. 10 is a flow chart of an operation to calculate a certain playback location of the compressed audio file in the compressed audio player shown in FIG. 7;

FIG. 11 is a block diagram showing a detail structure of a compressed audio file used in the compressed audio player shown in FIG. 7;

FIG. 12 is a location table of basic data streams for the compressed audio player in accordance with the block diagram shown in FIG. 11;

FIG. 13 is a block diagram of a compressed audio player, according to the third embodiment;

FIG. 14 is a conceptual diagram of a sample compressed audio file used in the compressed audio player shown in FIG. 13;

FIG. 15 is a location table of basic data streams for the compressed audio player in accordance with the block diagram shown in FIG. 13;

FIG. 16 is an information table of audio data streams for the compressed audio player in accordance with the block diagram shown in FIG. 13;

FIG. 17 is a block diagram showing a basic structure of a sample compressed audio file used in the compressed audio player shown in FIG. 13;

FIG. 18 is a block diagram showing a detail structure of a single audio stream data included in the sample compressed audio file used in the compressed audio player shown in FIG. 13;

FIG. 19 is a flow chart of an operation to calculate a certain playback location of the compressed audio file in the compressed audio player shown in FIG. 13;

FIG. 20 is a block diagram showing a basic structure of another compressed audio file used in the compressed audio player shown in FIG. 13;

FIG. 21 is a location table of basic data streams of the compressed audio file shown in FIG. 20 in accordance with the block diagram shown in FIG. 13;

FIG. 22 is a information table of basic data streams of the compressed audio file shown in FIG. 20 in accordance with the block diagram shown in FIG. 13; and

FIG. 23 is a block diagram showing a detail structure of an audio data stream 2 in a compressed audio file shown in FIG. 20.

### DETAILED DESCRIPTION OF THE PREFERRED EMBODIMENTS

The preferred embodiment of the invention is explained together with drawings as follows. In each drawing, the same reference numbers designate the same or similar components.

### The First Embodiment

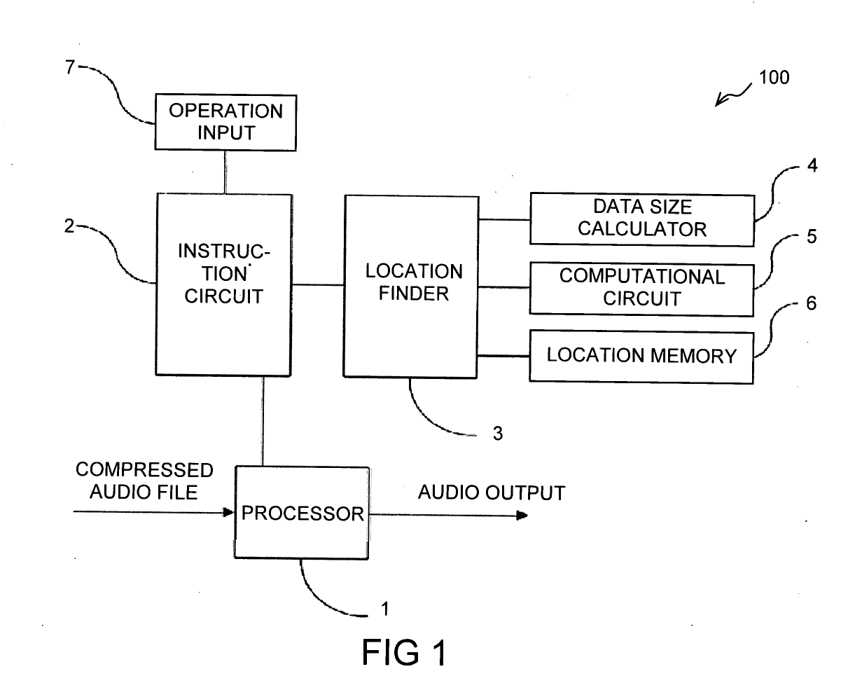

FIG. 1 is a block diagram of a compressed audio player 100, according to the first embodiment. The compressed audio player 100 includes a processor 1, an instruction circuit 2, a location finder 3, a data size calculator 4, a computational circuit 5, a location memory 6 and an operation input 7. The processor 1 reads a compressed audio file, and converts it to audio data for outputting an audio. The instruction circuit 2 sends an instruction of performing either a fast-forwarding or a fast-rewinding to the processor 1. In response to the instruction from the instruction circuit 2, the processor 1 skips the compressed audio file to the designated location, and outputs (replays) the converted audio data from the designated location. The operation input 7 receives a demand as to the fast-forwarding or the fast-rewinding from a user of the compressed audio player 100, and sends such a demand to the instruction circuit 2. The location finder 3 calculates a relative location of the designated basic data stream, based on the head location of the compressed audio file, in response to an instruction signal for calculating a playback location of the compressed audio file. In the first embodiment, each basic data stream includes a single frame recorded in the compressed audio file.

The data size calculator 4 calculates an average basic data stream size AvgDataStream indicating an average size of the basic data streams each having varied length. The average basic data stream size AvgDataStream is calculated by the following equation;

AvgDataStream=(FileSize−AbsFrame1st)/NumFrame

where FileSize is a file size of the compressed audio file to be replayed, AbsFrame1st is a head location of the first frame and NumFrame is a total number of the frames recorded in the compressed audio file.

The computational circuit 5 calculates a logical location by integrating a number of the basic data stream with the average basic data stream size. The basic data streams are numbered as follows. A basic data stream 1, which is the first stream from the header, is numbered as “0”, a basic data stream 2 , which is the second stream from the header, is numbered as “1”, and a basic data stream N, which is the Nth stream from the header, is numbered as “N-1”. For example, the logical location of the basic data stream 3 is calculated by integrating the size of the average basic data stream with 2.

The location memory 6 stores location subtraction data, which shows a difference between the relative location and the logical location of each basic data stream. The location subtraction data is stored in the location table format in the location memory 6. The location subtraction data [symbol] DataStreamN of the basic data stream N, which is the N^{th} stream from the header is calculated by the following equation;

[symbol]

DataStreamN=AbstDataStreamN−AbstFram1st−AvgDataStreamN

where AbstDataStreamN is a relative location of the basic data stream N measured from the head of the compressed data file, AbstFram1st is a relative location of the basic data stream 1 measured from the head of the compressed data file and AvgDataStreamN is a logical location of the basic data stream N.

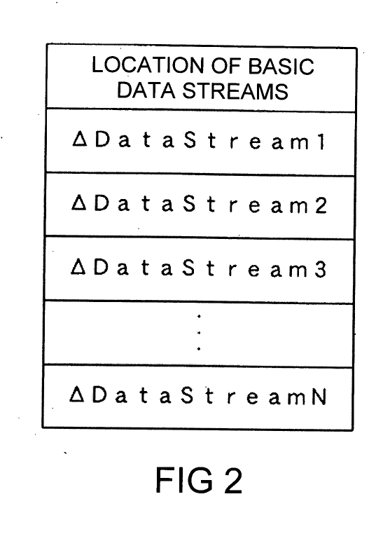

FIG. 2 is a location table of the basic data streams stored in the location memory 6 shown in FIG. 1. In the location table, the location subtraction data of each basic data stream are stored in the numbering order of the basic data streams. Namely, the [symbol] DataStream1 is stored at the top of the table, and the [symbol] DataStream2 the next, so on. The location memory 6 also stores a total size of the compressed audio file to be replayed, a total number of the frames and a relative head-location of the frame 1, which is the first frame.

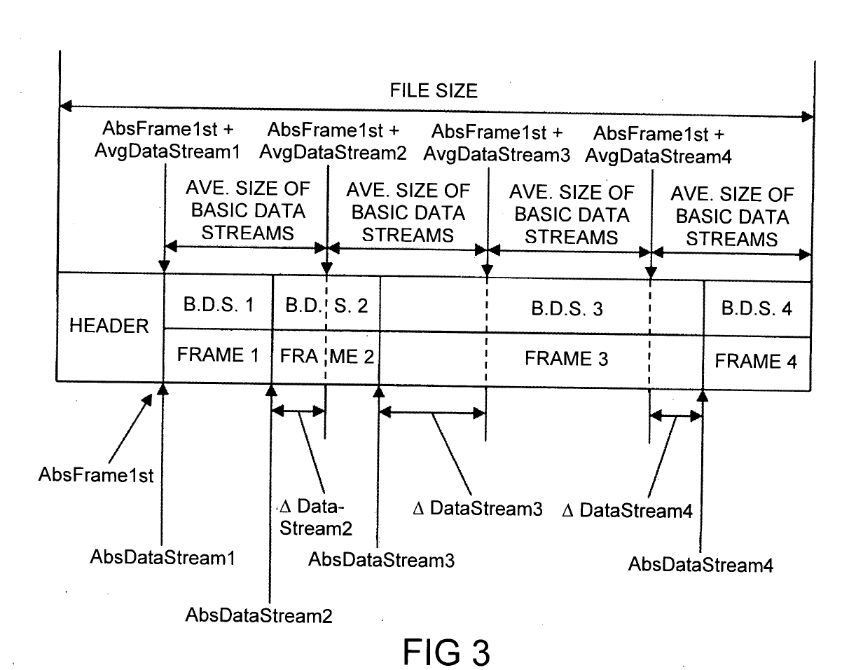

FIG. 3 is a block diagram showing a basic structure of a compressed audio file used in the compressed audio player shown in FIG. 1. In FIG. 3, the average basic data stream size, the logical location and the location subtraction data are also illustrated. In FIG. 3, the head-location of the frame 1 is illustrated as AbstFrame1st, the logical location of the basic data stream N is illustrated as AveDataStreamN, the location subtraction data of the basic data stream N is illustrated as [symbol] DataStreamN. Furthermore, the relative location of the basic data stream N, which is measured from the head of the compressed audio file, is illustrated as AbstDataStreamN.

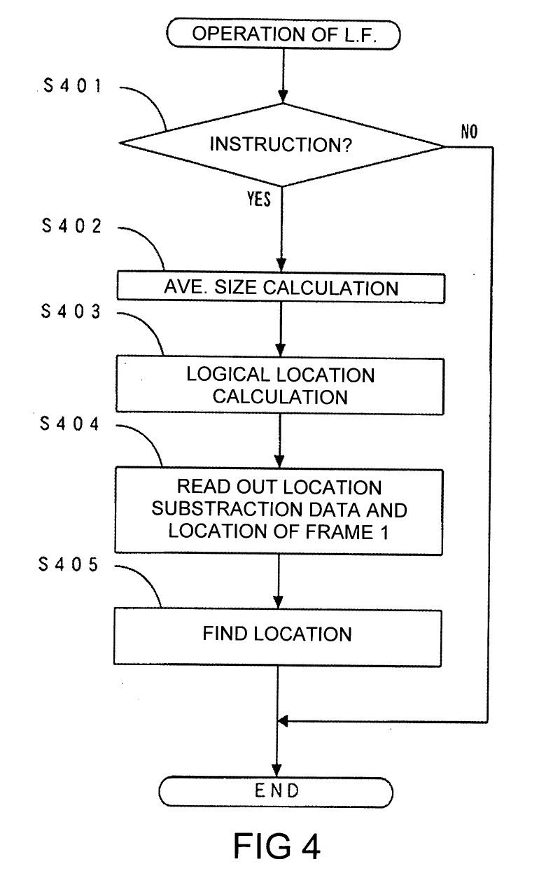

Next, an operation to calculate a certain playback location of the compressed audio file is explained below with reference to FIG. 4. FIG. 4 shows a flow chart for the operation performed in the location finder 3 of FIG. 1. The operation is performed periodically by an interruption of the regular replay of the compressed audio file:

In the Step S401, the location finder 3 confirms whether or not the instruction of performing either a fast-forwarding or a fast-rewinding is received from the instruction circuit 2. If no instruction is received, operation is ended. When the location finder 3 confirms the instruction, it sends an instruction to the data size calculator 4 for calculating an average basic data stream size AvgDataStream in the Step S402. The data size calculator 4 calculates the average basic data stream size AvgDataStream in response to the instruction from the location finder 3. After the average basic data stream size AvgDataStream is calculated, then the location finder 3 sends an instruction to the computational circuit 5 for calculating a logical location by integrating a number of the basic data stream with the average basic data stream size in the Step S403. The computational circuit 5 calculates the logical location in response to the instruction from the location finder 3. After the logical location is calculated, then location finder 3 accesses the location memory 6 to read out the location subtraction data corresponding to the basic data stream to be replayed and the relative location of the first frame in the Step S404. In the Step S405, the location finder 3 calculates the location of the basic data stream to be played, and determines the calculated location as a playback location. The playback location of the basic data stream AbsDataStreamN is calculated by the following equation;

AbsDataStreamN=(AbsFrame1st+AveDataStreamN)+ [symbol] DataStreamN

where [symbol] DataStreamN is the location subtraction data of the basic data stream N, AveDataStreamN is the logic location and AbsFrame1st is the head-location of the frame 1.

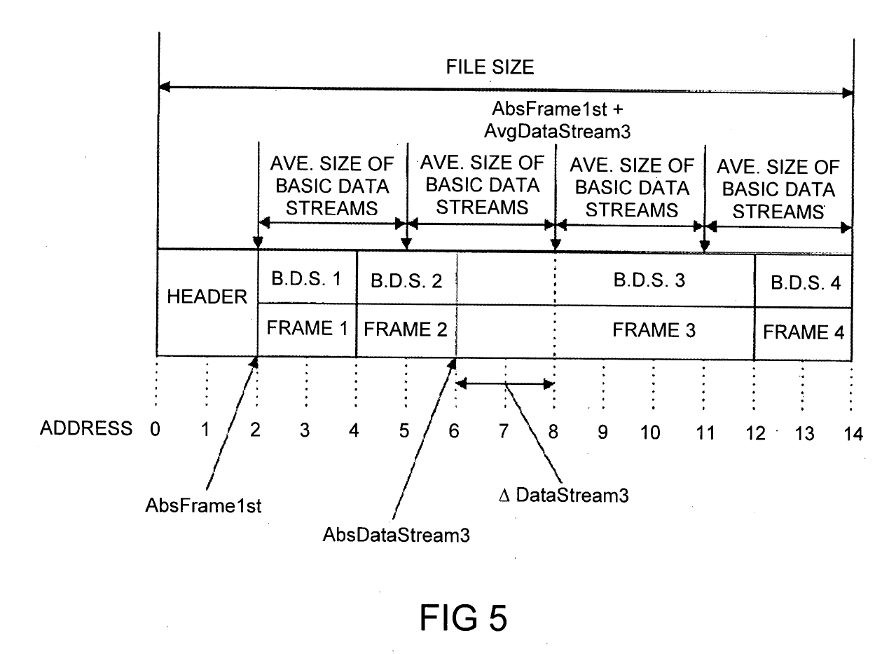

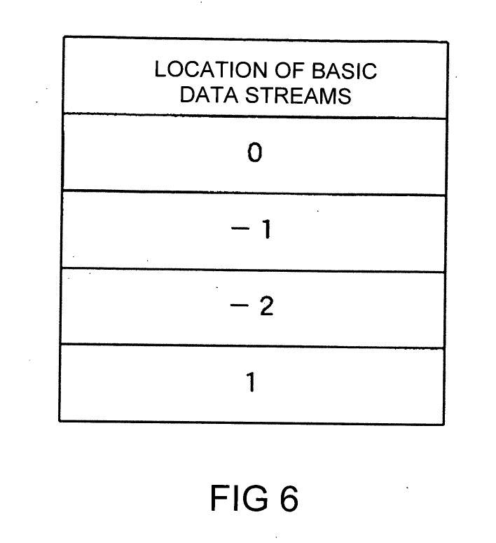

Now, a structure of a sample compressed audio file to be replayed is illustrated in FIG. 5. The location subtraction data corresponding to each basic data stream of the sample compressed audio file, a total file size of the sample compressed audio file, a total numbers of the frames recorded in the sample compressed audio file and the relative head-location of the frame 1 has been obtained at the time the sample compressed audio file was played at the first time by the player 100 illustrated in FIG. 1, and such data are stored. Thus, the location memory 6 stores the location data of the basic data streams illustrated in the location table of the FIG. 6. The location memory 6 also stores the file size of the sample compressed audio file, which is fourteen (14), the numbers of the frame, which are four (4), and the head-location of the frame 1, which is at two (2).

After the operation input 7 sends the instruction circuit 2 a demand for fast-forwarding the sample compressed audio file to the basic data stream 3 and for replaying from the frame 3 corresponding to the basic data stream 3, the instruction circuit 2 send the location finder 3 an instruction for calculating the location of the basic data stream 3. In response to the instruction from the location finder 3, the location of the basic data stream 3 is calculated by the data size calculator 4, the computational circuit 5 and the location memory 6 as follows.

As described above, since the average basic data stream size AvgDataStream is calculated by (FileSize(14)−AbsFrame1st(2))/NumFrame(4), that is, “3”. The logical location of the basic data stream 3 is calculated by 2×3, that is, “6”. The location subtraction data Δ DataStream3 corresponding to the basic data stream 3 is “−2”. Thus, the location of the basic data stream 3 is “6”, which is calculated by 2+6+(−2). In FIG. 5, the head-location of the frame 1 is expressed with AbsFrame1st, the logical location of the basic data stream 3 is expressed with AvgDataStream3, the location subtraction data corresponding to the basic data stream 3 is Δ DataStream3, and the location of the basic data stream 3 is expressed with AbsDataStream3.

After the location finder 3 calculates the location to be replayed, the instruction circuit 2 sends the processor 1 an instruction for skipping the sample compressed audio file to the calculated location, and for replaying the sample compressed audio file from the calculated location. The processor 1 skips the sample compressed audio file to the calculated location, and replays the sample compressed audio file from the calculated location, in response to the instruction from the instruction circuit 2.

According to the audio player of the first embodiment, since the location subtraction data corresponding to each basic data stream are stored, the location of the desired basic data stream can be calculated. Thus, the compressed audio file in any compressed format can be replayed at any designated locations. As described above, the location subtraction data is calculated by the differences between the relative location of a certain basic data stream and the logical location corresponding to the basic data stream. In the first embodiment, since the size of the basic data stream is set as the same as that of the corresponding frame, the size of the location subtraction data is equal to or the less than the maximum size of a frame. Thus, a capacity MemSize (byte) of the location memory 6 required to store the location subtraction data is calculated by the following equation;

MemSize=NumFrame×Log₂(MaxFrame)

where MaxFrame(byte) is the maximum size of the frame and NumFrame is a total number of the frames recorded in the compressed audio file.

In the ACC format, since the maximum size of the frame is “1536<2¹¹”, the capacity MemSize (byte) to store the location subtraction data is less than “NumFrame×11”. To the contrary, in the case that the locations of all frames are stored, when the maximum size of the frame is “2³²”, the capacity MemSize (byte) is “NumFrame×32”. Thus, compared to the case that the locations of all frames are stored, the capacity can be reduced to “11/32”, according to the first embodiment.

### The Second Embodiment

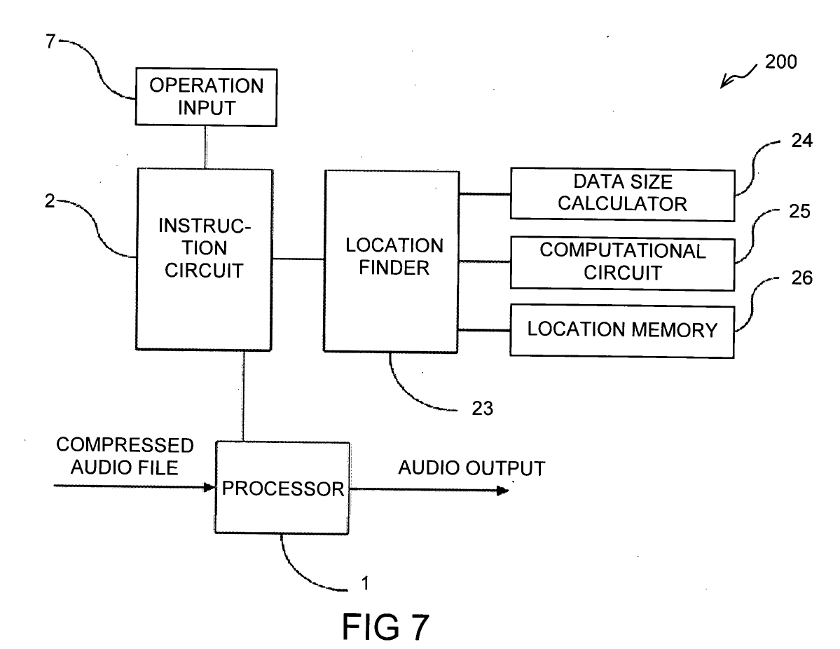

FIG. 7 is a block diagram of a compressed audio player 200, according to the second embodiment. In FIG. 7, the same reference numbers designate the same or similar components used in FIG. 1.

The compressed audio player 200 includes a processor 1, an instruction circuit 2, a location finder 23, a data size calculator 24, a computational circuit 25, a location memory 26 and an operation input 7. The processor 1 reads a compressed audio file, and converts it to audio data for outputting an audio. The instruction circuit 2 sends an instruction of performing either a fast-forwarding or a fast-rewinding to the processor 1. In response to the instruction from the instruction circuit 2, the processor 1 skips the compressed audio file to the designated location, and outputs (replays) the converted audio data from the designated location. The operation input 7 receives a demand as to the fast-forwarding or the fast-rewinding from a user of the compressed audio player 200, and sends such a demand to the instruction circuit 2. The location finder 23 calculates a relative location of the designated basic data stream, based on the head location of the compressed audio file, in response to an instruction signal for calculating a playback location of the compressed audio file. In the second embodiment, each basic data stream includes a plurality of frames recorded in the compressed audio file wherein the frames are in serial. Specifically, in the second embodiment, each basic data stream includes eight (8) serial frames recorded in the compressed audio file.

The data size calculator 24 calculates an average basic data stream size AvgDataStream indicating an average size of the basic data streams each having varied length. The average basic data stream size AvgDataStream is calculated by the following equation;

AvgDataStream=[(FileSize−AbsFrame1st)/NumFrame]×StreamFrameNum

where FileSize is a file size of the compressed audio file to be replayed, AbsFrame1st is a head location of the first frame, NumFrame is a total number of the frames recorded in the compressed audio file and StreamFrameNum is a number of the frames in the one basic data stream, which is eight (8) in the second embodiment as described.

The computational circuit 25 calculates a logical location by integrating a number of the basic data stream with the average basic data stream size. The basic data streams are numbered as follows. A basic data stream 1, which is the first stream from the header, is numbered as “0”, a basic data stream 2 , which is the second stream from the header, is numbered as “1”, and a basic data stream N, which is the Nth stream from the header, is numbered as “N-1”. For example, the logical location of the basic data stream 3 is calculated by integrating the size of the average basic data stream with 2.

The location memory 26 stores location subtraction data, which shows a difference between the relative location and the logical location of each basic data stream. The location subtraction data is stored in the location table format in the location memory 26. The location subtraction data [symbol] DataStreamN of the basic data stream N, which is the Nth stream from the header is calculated by the following equation;

[symbol]

DataStreamN=AbstDataStreamN−AbstFram1st−AvgDataStreamN

where AbstDataStreamN is a relative location of the basic data stream N measured from the head of the compressed data file, AbstFram1st is a relative location of the basic data stream 1 measured from the head of the compressed data file and AvgDataStreamN is a logical location of the basic data stream N.

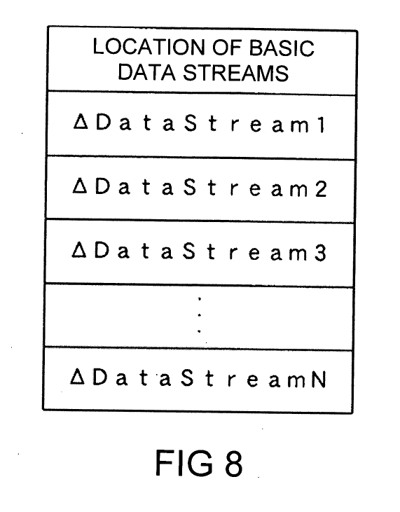

FIG. 8 is a location table of the basic data streams stored in the location memory 26 shown in FIG. 7. In the location table, the location subtraction data of each basic data stream are stored in the numbering order of the basic data streams. Namely, the [symbol] DataStream1 is stored at the top of the table, and the [symbol] DataStream2 the next, so on. The location memory 26 also stores a total size of the compressed audio file to be replayed, a total number of the frames, a relative head-location of the frame 1, which is the first frame, and a number of the frame in the one basic data stream.

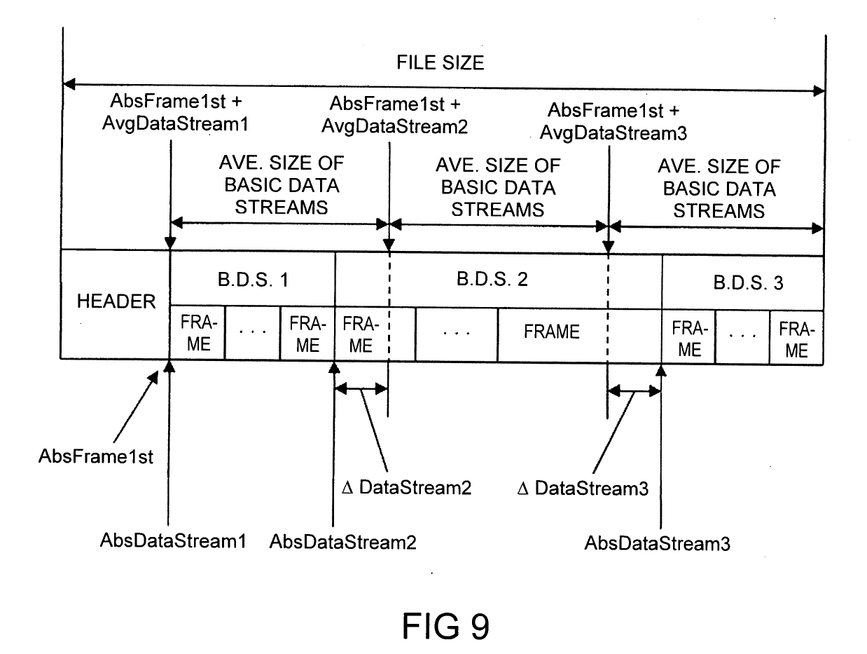

FIG. 9 is a block diagram showing a basic structure of a compressed audio file used in the compressed audio player shown in FIG. 7. In FIG. 9, the average basic data stream size, the logical location and the location subtraction data are also illustrated. In FIG. 9, the head-location of the frame 1 is illustrated as AbstFrame1st, the logical location of the basic data stream N is illustrated as AveDataStreamN, the location subtraction data of the basic data stream N is illustrated as Δ DataStreamN. Furthermore, the relative location of the basic data stream N, which is measured from the head of the compressed audio file, is illustrated as AbstDataStreamN.

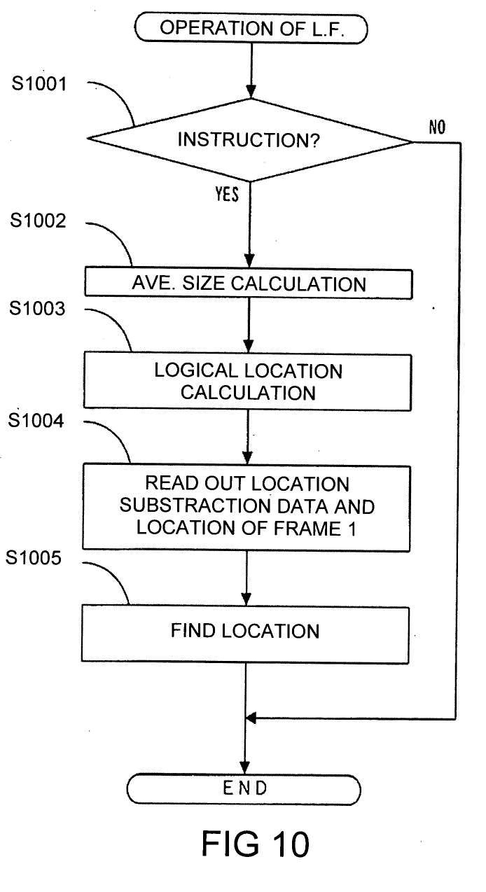

Next, an operation to calculate a certain playback location of the compressed audio file is explained below with reference to FIG. 10. FIG. 10 shows a flow chart for the operation performed in the location finder 23 of FIG. 7. The operation is performed periodically by an interruption of the regular replay of the compressed audio file.

In the Step S1001, the location finder 23 confirms whether or not the instruction of performing either a fast-forwarding or a fast-rewinding is received from the instruction circuit 2. If no instruction is received, operation is ended. When the location finder 23 confirms the instruction, it sends an instruction to the data size calculator 24 for calculating an average basic data stream size AvgDataStream in the Step S1002. The data size calculator 24 calculates the average basic data stream size AvgDataStream in response to the instruction from the location finder 23. After the average basic data stream size AvgDataStream is calculated, then the location finder 23 sends an instruction to the computational circuit 25 for calculating a logical location of the basic data stream to be replayed by integrating a number of the basic data stream with the average basic data stream size in the Step S1003. The computational circuit 25 calculates the logical location in response to the instruction from the location finder 23. After the logical location is calculated, then location finder 23 accesses the location memory 26 to read out the location subtraction data corresponding to the basic data stream to be replayed and the relative location of the first frame in the Step S1004. In the Step S1005, the location finder 23 calculates the location of the basic data stream to be played, and determines the calculated location as a playback location. The playback location of the basic data stream AbsDataStreamN is calculated by the following equation;

AbsDataStreamN=(AbsFrame1st+AveDataStreamN)+ [symbol] DataStreamN

where [symbol] DataStreamN is the location subtraction data of the basic data stream N, AveDataStreamN is the logic location and AbsFrame1st is the head-location of the frame 1.

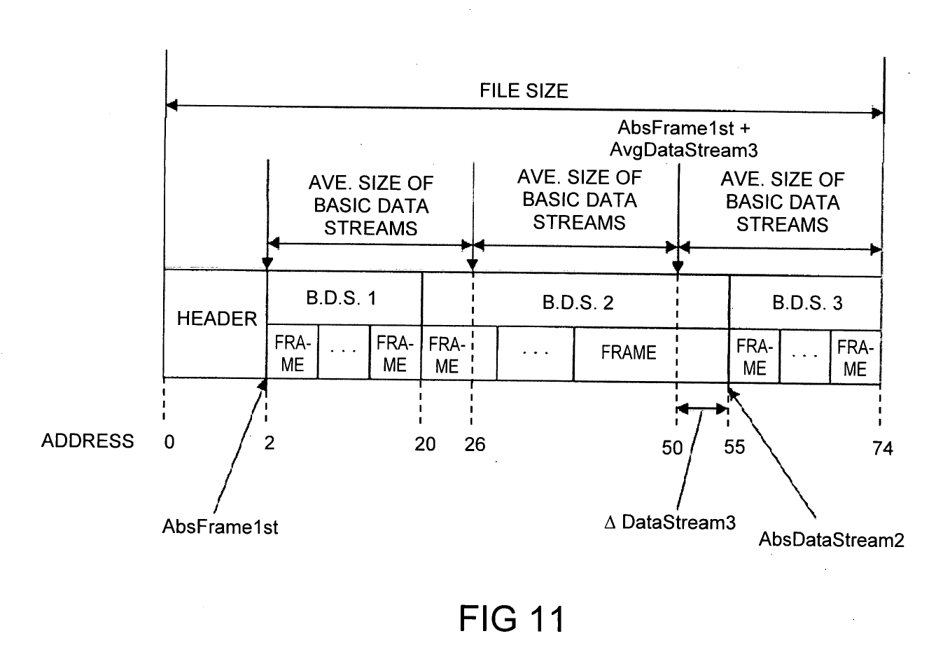

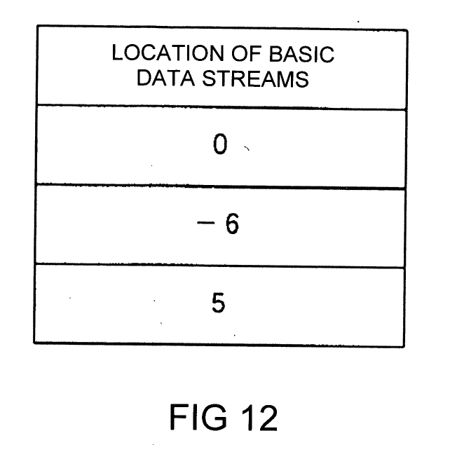

Now, a structure of a sample compressed audio file to be replayed is illustrated in FIG. 11. The location subtraction data corresponding to each basic data stream of the sample compressed audio file, a total file size of the sample compressed audio file, a total numbers of the frames recorded in the sample compressed audio file and the relative head-location of the frame 1 have been obtained at the time the sample compressed audio file was played at the first time by the player 200 illustrated in FIG. 7, and such data are stored. Furthermore, a number of the frames in one basic data stream is preset, and such information as to the number is stored in the location memory 26. In this embodiment, the number is preset at eight (8), as described above. Thus, the location memory 26 stores the location data of the basic data streams illustrated in the location table of the FIG. 12. The location memory 26 also stores the file size of the sample compressed audio file, which is seventy-four (74), the numbers of the frame, which are twenty-four (24), the head-location of the frame 1, which is at two (2), and the frame numbers in one basic data stream, which are eight (8), as described.

After the operation input 7 sends the instruction circuit 2 a demand for fast-forwarding the sample compressed audio file to the basic data stream 3 and for replaying from the frame 3 corresponding to the basic data stream 3, the instruction circuit 2 send the location finder 23 an instruction for calculating the location of the basic data stream 3. In response to the instruction from the location finder 23, the location of the basic data stream 3 is calculated by the data size calculator 24, the computational circuit 25 and the location memory 26 as follows.

As described above, since the average basic data stream size AvgDataStream is calculated by [{FileSize(74)−AbsFrame1st(2)}/NumFrame(24)×StreamFrameNum(8), that is, “24”. The logical location of the basic data stream 3 is calculated by 2×24, that is, “48”. The location subtraction data [symbol] DataStream3 corresponding to the basic data stream 3 is “5”. Thus, the location of the basic data stream 3 is “55”, which is calculated by 2+48+5. In FIG. 11, the head-location of the frame 1 is expressed with AbsFrame1st, the logical location of the basic data stream 3 is expressed with AvgDataStream3, the location subtraction data corresponding to the basic data stream 3 is [symbol] DataStream3, and the location of the basic data stream 3 is expressed with AbsDataStream3.

After the location finder 23 calculates the location to be replayed, the instruction circuit 2 sends the processor 1 an instruction for skipping the sample compressed audio file to the calculated location, and for replaying the sample compressed audio file from the calculated location. The processor 1 skips the sample compressed audio file to the calculated location, and replays the sample compressed audio file from the calculated location, in response to the instruction from the instruction circuit 2.

According to the audio player of the second embodiment, since the location subtraction data corresponding to each basic data stream are stored, the location of the desired basic data stream can be calculated. Thus, the compressed audio file in any compressed format can be replayed at any designated locations. As described above, the location subtraction data is calculated by the differences between the relative location of a certain basic data stream and the logical location corresponding to the basic data stream. In the second embodiment, since the size of the basic data stream includes eight (8) sequential frames, the size of the location subtraction data is equal to or the less than “maximum size of a frame×8”.

Thus, a capacity MemSize (byte) of the location memory 26 required to store the location subtraction data is calculated by the following equations;

$$\begin{matrix}MemSize = ( NumFrame / 8 ) \times {Log}_{2} ( MaxFrame \times 8 ) \\ = ( NumFrame / 8 ) \times [ {Log}_{2} ( MaxFrame ) \times {Log}_{2} ( 8 ) ] \\ = ( NumFrame / 8 ) \times [ {Log}_{2} ( MaxFrame ) + 3 ]\end{matrix}$$

where MaxFrame(byte) is the maximum size of the frame and NumFrame is a total number of the frames recorded in the compressed audio file.

In the ACC format, since the maximum size of the frame is “1536<2¹¹”, the capacity MemSize (byte) to store the location subtraction data is less than “(NumFrame/8)×14”. To the contrary, in the case that the locations of all frames are stored, when the maximum size of the frame is “2³²”, the capacity MemSize (byte) is “NumFrame×32”. Thus, compared to the case that the locations of all frames are stored, the capacity can be reduced to “7/128”, according to the second embodiment. Moreover, compared with the first embodiment, the capacity can be reduced to “7/44” in the second embodiment.

### The Third Embodiment

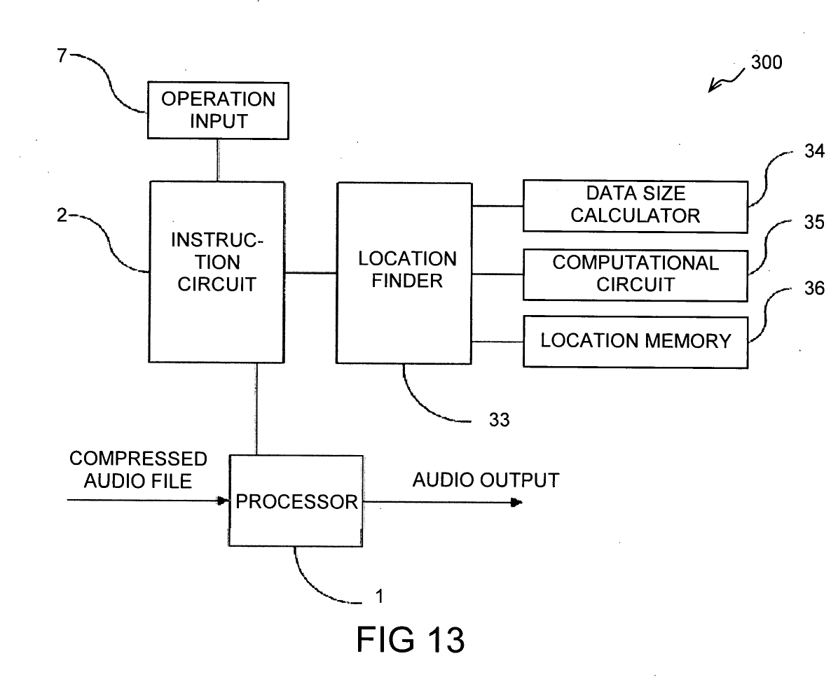

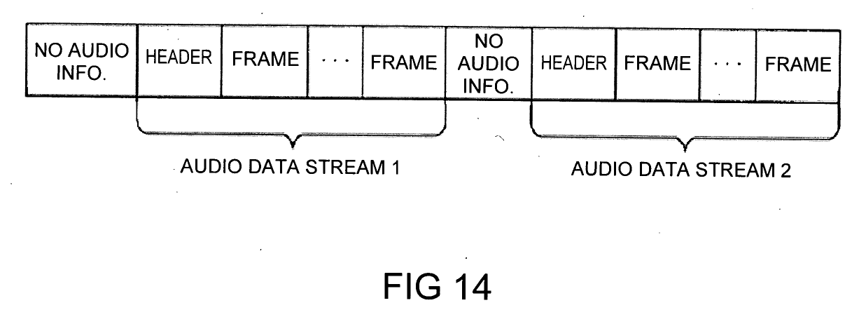

FIG. 13 is a block diagram of a compressed audio player 300, according to the second embodiment. In FIG. 13, the same reference numbers designate the same or similar components used in FIG. 1 or FIG. 7. FIG. 14 shows a conceptual diagram of a sample compressed audio file used in the compressed audio player shown in FIG. 13. The sample compressed audio file in FIG. 14 includes some parts which are not necessary to replay the compressed audio file, such as a title of a song, names of the artists or images, in addition to some parts, which are necessary to replay the compressed audio file. The sample compressed audio file includes a plurality of audio data streams, each of which includes sequential frames in the parts necessary to be replayed.

The compressed audio player 300 includes a processor 1, an instruction circuit 2, a location finder 33, a data size calculator 34, a computational circuit 35, a location memory 36 and an operation input 7. The processor 1 reads a compressed audio file, and converts it to audio data for outputting an audio. The instruction circuit 2 sends an instruction of performing either a fast-forwarding or a fast-rewinding to the processor 1. In response to the instruction from the instruction circuit 2, the processor 1 skips the compressed audio file to the designated location, and outputs (replays) the converted audio data from the designated location. The operation input 7 receives a demand as to the fast-forwarding or the fast-rewinding from a user of the compressed audio player 300, and sends such a demand to the instruction circuit 2. The location finder 33 calculates a relative location of the designated basic data stream, based on the head location of the compressed audio file, in response to an instruction signal for calculating a playback location of the compressed audio file. In the third embodiment, each basic data stream includes a plurality of frames recorded in the audio data stream of the compressed audio file wherein the frames are in serial. Specifically, in the second embodiment, each basic data stream includes eight (8) serial frames recorded in the compressed audio file.

The data size calculator 34 calculates an average basic data stream size AvgDataStream within each audio data stream. More precisely, as described above, the sample compressed audio file includes a plurality of audio data streams, each of which includes a plurality of basic data stream having a plurality of frames. The data size calculator 34 calculates an average basic data stream size AvgDataStream of each audio data stream. Thus, the average basic data stream size AvgDataStream of the first audio data stream may be different from that of the second audio data stream. The average basic data stream size AvgDataStream of the audio data stream A is calculated by the following equation;

AvgDataStream=(MusicStreamSize−NumFrame)×StreamFrameNum

where MusicStreamSize is a size, which is subtracted with a size of the header from the size of the audio data stream A included in the compressed audio file to be replayed, NumFrame is a total number of the frames included in the audio data stream and StreamFrameNum is a number of the frames included in the one basic data stream.

The computational circuit 35 calculates a logical location with respect to every audio data streams by integrating a number of the basic data stream in a certain audio data stream with the average basic data stream size in that audio data stream. The basic data streams are numbered as follows. A number of the basic data stream, which is the X^{th} basic data stream counted from the head of the compressed audio file, is calculated as “X-N” where the basic data stream, which is the first basic data stream in the audio data stream in which the X^{th} basic data stream is included, is the N^{th} basic data stream counted from the head of the compressed audio file. For example, a number of the third basic data stream in the third audio data stream is counted by the following steps. If the first audio data stream includes 6 basic data streams, and the second audio data stream includes 9 basic data streams, the first basic data stream in the third audio data stream is recognized as the 16^{th} basic data stream, that is the number “N”, and the third basic data stream in the third audio data stream is recognized as the 18^{th} basic data stream, that is the number “X”. Thus, the number of the third basic data stream in the third audio data stream is calculated by “20−18”, that is “2”. The logical location of the third basic data stream in the third audio data stream is calculated by integrating the average basic data stream size of the third audio stream with “2”.

The location memory 36 stores location subtraction data, which shows a difference between the relative location and the logical location of each basic data stream. The location subtraction data is stored in the location table format in the location memory 36. The location subtraction data [symbol] DataStreamN of the basic data stream N, which is the Nth stream from the header of the audio data stream A is calculated by the following equation;

[symbol]

DataStreamN=AbstDataStreamN−AbstFram1st−AvgDataStreamN

where AbstDataStreamN is a relative location of the basic data stream N in the audio data stream A, AbstFram1st is a relative location of the basic data stream 1 of the audio data stream A and AvgDataStreamN is a logical location of the basic data stream N of the audio data stream A.

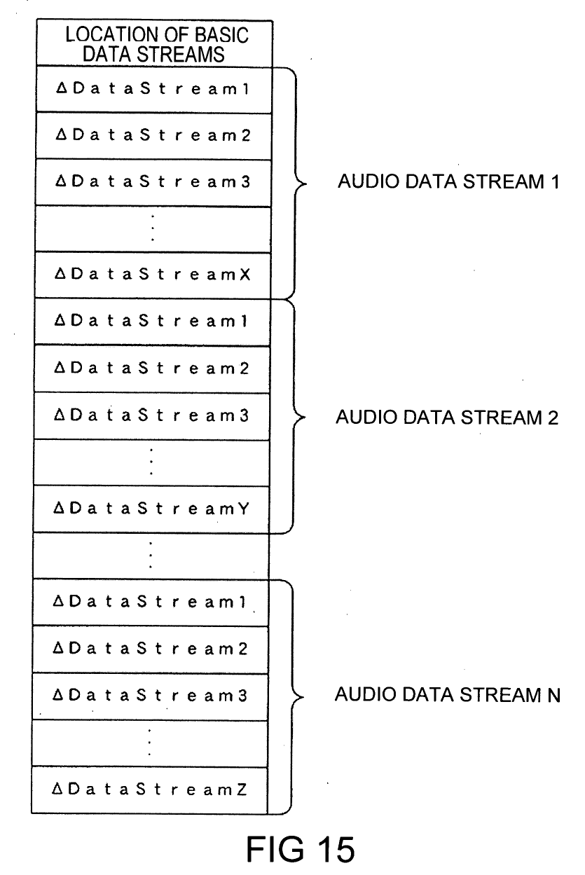

FIG. 15 is a location table of the basic data streams stored in the location memory 36 shown in FIG. 13. In the location table, the location subtraction data of each audio data stream are stored in the numbering order of the basic data streams. Namely, the [symbol] DataStream1 of the audio data stream 1 is stored at the top of the table, and the [symbol] DataStream2 the next, so on. After all location subtraction data of the audio data stream 1 is recorded, then the location subtraction data of the audio data stream 2 are stored in the same way as the audio data stream 1. The location memory 36 also stores a number of all audio data streams included in the compressed audio data file to be replayed, a total number of the frames recorded in all audio data streams and an information table in which information of each audio data stream is stored.

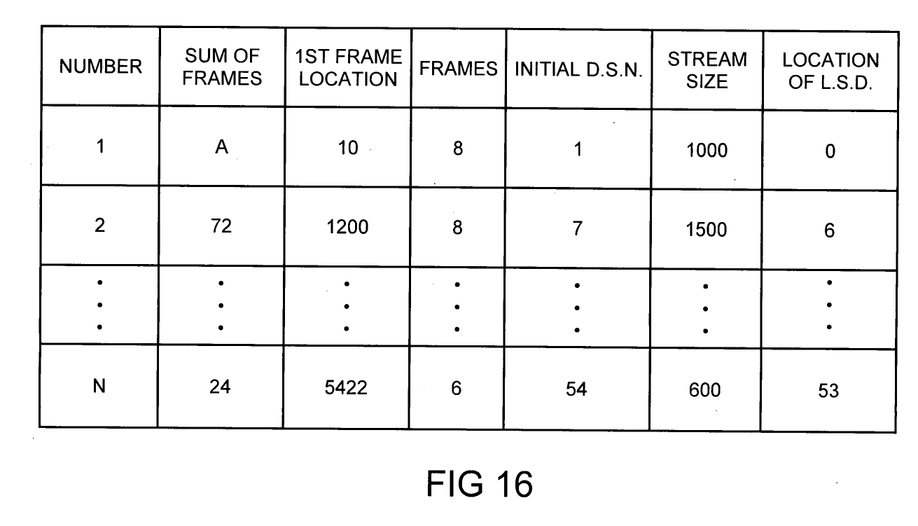

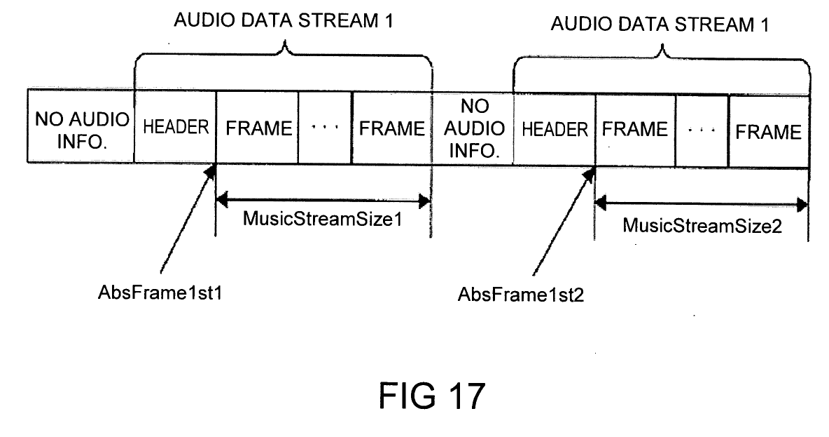

FIG. 16 is an information table of the audio data streams for the compressed audio player in accordance with the block diagram shown in FIG. 13. In the information table, the information of the audio data streams is stored in the numbering order. That is, the information of the audio data stream 1 is stored in the top row of the information table, and the information of the audio data stream 2 is stored in the second row of the information table. In the information table, “NUMBER” indicates the audio data stream number and “SUM OF FRAMES” indicates a sum of the frames recorded in each audio data stream. “1^{ST} FRAME LOCATION” indicates a relative location of the first frame in each audio data stream. “FRAMES” indicates numbers of the frame recorded in one basic data stream. Thus, the number of the basic data streams in each audio data stream can be calculated from the “SUM OF FRAMES” and “FRAMES”. “INITIAL D.S.N”, which is an initial basic data stream number, indicates the number of the first data stream in each audio data stream counted from the basic data stream 1 of the audio data stream 1. Thus, when the “INITIAL D.S.N” indicates “7” in the second raw, this means that there are six basic data streams in the audio data stream 1, and the basic data stream 1 of the audio data stream 2 is the seventh basic data stream counted from the basic data stream 1 of the audio data stream 1. “STREAM SIZE”, which is expressed as “MusicStreamSize” in FIG. 17, is a stream size, which is subtracted with a size of the header from the size of the audio data stream included in the compressed audio file to be replayed indicates the size, and “Location of L.S.D.”, which is a location of the location subtraction data, indicates the location in the location table. For example, when the “Location of L.S.D.” indicates “6” in the second raw, this means that the location subtraction data of the basic data stream 1 of the audio data stream 2 is stored in the sixth row of the location table shown in FIG. 15.

FIG. 17 is a block diagram showing a basic structure of a sample compressed audio file used in the compressed audio player shown in FIG. 13. In FIG. 17, a head location of the first frame, which is expressed as “Absframe1st”, in each audio data stream and the stream size MusicStreamSize, which is subtracted with a size of the header from the size of the audio data stream, are illustrated.

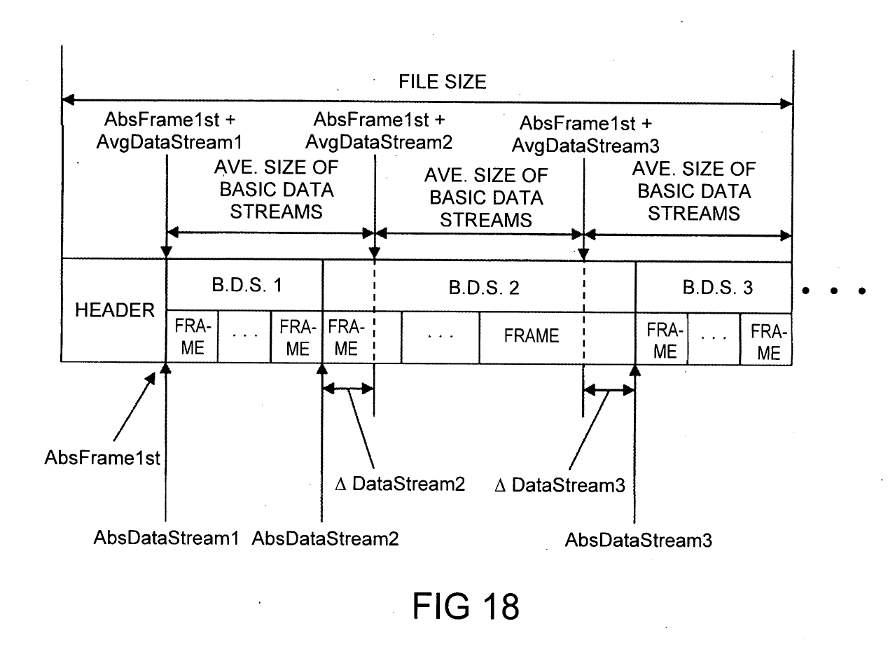

FIG. 18 is a block diagram showing a detail structure of a single audio stream data included in the sample compressed audio file used in the compressed audio player shown in FIG. 13. In FIG. 18, an average basic data stream size, logical locations of the basic data streams and the location subtraction data, of a certain audio data stream are also illustrated. In FIG. 18, the head-location of the frame 1 of the basic data stream 1 is illustrated as AbstFrame1st, the logical location of the basic data stream N is illustrated as AveDataStreamN, the location subtraction data of the basic data stream N is illustrated as [symbol] DataStreamN. Furthermore, the relative location of the basic data stream N, which is measured from the head of the compressed audio file, is illustrated as AbstDataStreamN.

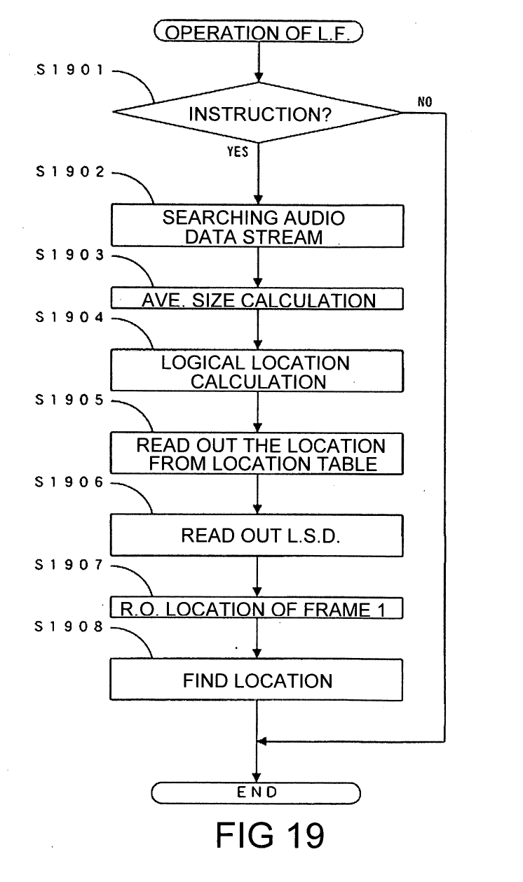

Next, an operation to calculate a certain playback location of the compressed audio file is explained below with reference to FIG. 19. FIG. 19 shows a flow chart for the operation performed in the location finder 23 of FIG. 7. The operation is performed periodically by an interruption of the regular replay of the compressed audio file.

In the Step S1901, the location finder 33 confirms whether or not the instruction of performing either a fast-forwarding or a fast-rewinding is received from the instruction circuit 2. If no instruction is received, operation is ended. When the location finder 33 confirms the instruction, it searches an audio data stream, which includes a basic data stream to be replayed in the Step S1902. Here, for the sake of the explanation of the operation, it is defined that the basic data stream to be replayed is the X^{th} basic data stream, which is the X^{th} counted from the head of the basic data stream in the compressed audio file. Under this definition, the search of the audio data stream is performed by the following steps. First, the location finder 33 reads out the data of “NUMBER”, the data of “SUM OF FRAMES” and the data of “FRAMES” from the information table shown in FIG. 16. Then, the location finder 33 finds the particular audio data stream, which is matched with the following conditions.
(1) the number of “FRAME” is equal to or the less than “X”, and
(2) [the number of “INITIAL D.S.N.”+(the number of “SUM OF FRAMES”/the number of “FRAMES”)] exceeds “X”
   As a result of the search, the searched audio data stream includes the basic data stream to be played.

In the step S1903, after the particular audio data stream was searched, the location finder 33 sends an instruction to the data size calculator 34 for calculating an average basic data stream size AvgDataStream of the basic data streams included in the searched audio data stream. The data size calculator 34 calculates the average basic data stream size AvgDataStream in response to the instruction from the location finder 33. After the average basic data stream size AvgDataStream is calculated, then the location finder 33 sends an instruction to the computational circuit 35 for calculating a logical location of the basic data stream to be replayed in the Step S1904. The computational circuit 35 calculates the logical location in response to the instruction from the location finder 33.

In the Step S1905, after the logical location is calculated, then the location finder 33 accesses the information table illustrated in FIG. 16 to read out a location of the location subtraction data indicated in the column of “LOCATION OF L.S.D.” in the audio data stream in which the basic data stream to be replayed is included. Based on the read-out information of the location of the location subtraction data, the location finder 33 accesses the location table shown in FIG. 15 to read out the location subtraction data corresponding to the audio data stream in which the basic data stream to be replayed in the Step S1906. Then, in the Step S1907, the location finder 33 also accesses the location table to read out the relative location of the first frame of the audio data stream in which the basic data stream to be replayed. In the is Step S1907, the location finder 33 calculates the location of the basic data stream to be played, and determines the calculated location as a playback location. The playback location of the basic data stream AbsDataStreamN is calculated by the following equation;

AbsDataStreamN=(AbsFrame1st+AveDataStreamN)+ [symbol] DataStreamN

where [symbol] DataStreamN is the location subtraction data of the basic data stream N, AveDataStreamN is the logic location and AbsFrame1st is the head-location of the frame 1.

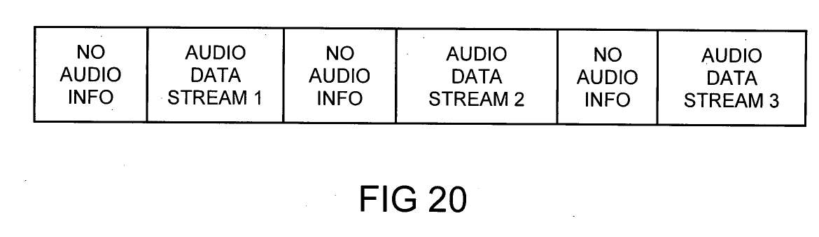

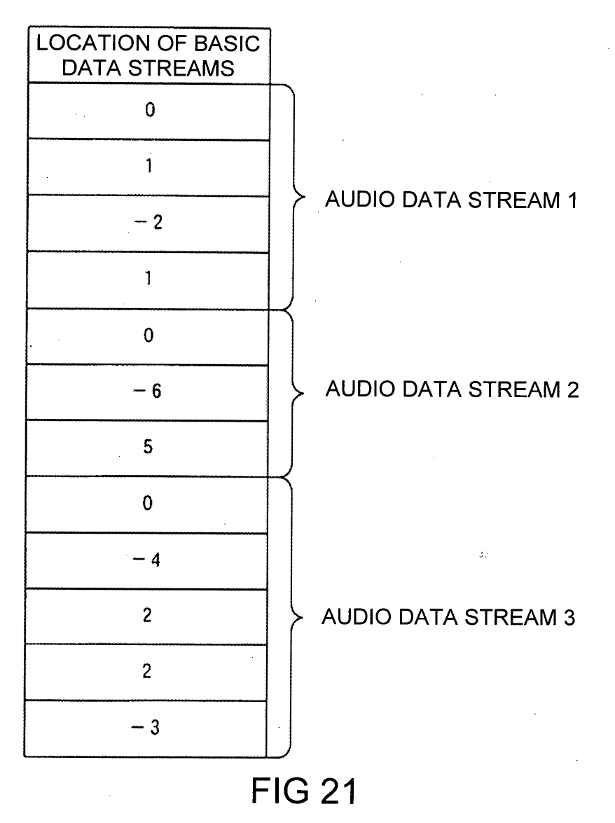

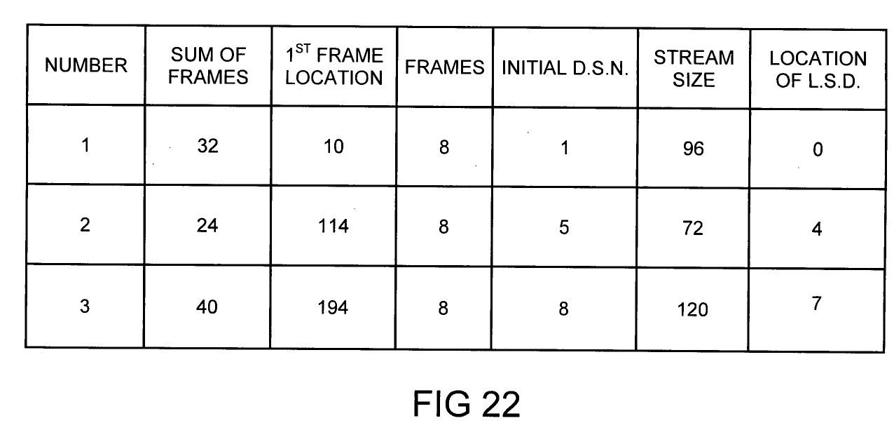

Now, a structure of a sample compressed audio file to be replayed is illustrated in FIG. 20. The sample compresses audio includes three (3) audio data streams. The location table of the sample compressed audio file is shown in FIG. 21, and the information table of the sample compressed audio file is shown in FIG. 22. The data stored in both tables shown in FIGS. 21 and 22 have been obtained at the time the sample compressed audio file was played at the first time by the player 200 illustrated in FIG. 7, and such data are stored in the location memory 36 in advance.

After the operation input 7 sends the instruction circuit 2 a demand for fast-forwarding the sample compressed audio file to the basic data stream 7, which is the seventh basic data stream counted from the head of the basic data stream, and for replaying the sample compressed audio file from that location, the instruction circuit 2 send the location finder 33 an instruction for calculating the location of the basic data stream 7. In response to the instruction from the location finder 33, the location of the basic data stream 7 is calculated by the following steps.

Initially, the location finder 33 searches an audio data stream, which includes a basic data stream 7. As described in the information table of the FIG. 22, the initial data stream number (INITIAL D.S.N.), the sum of the frames (SUM OF FRAMES) and the number of the frames (FRAMES) of the audio data stream 1 are “1”, “32” and “8”, respectively. Since the initial data stream number is indicated as “1”, it is less than “7” so that the first equation described above is satisfied. Since [the number of “INITIAL D.S.N.” (1)+(the number of “SUM OF FRAMES” (32)/the number of “FRAMES” (8))] is equal to “5”, which does not exceed “7”, the second equation described above is not satisfied. Thus, it is recognized that the basic data stream 7 is not included in the audio data stream 1. As well, the initial data stream number (INITIAL D.S.N.), the sum of the frames (SUM OF FRAMES) and the number of the frames (FRAMES) of the audio data stream 2 are “5”, “24” and “8”, respectively. Since the initial data stream number is indicated as “5”, it is less than “7” so that the first equation described above is satisfied. Since [the number of “INITIAL D.S.N.” (5)+(the number of “SUM OF FRAMES” (24)/the number of “FRAMES” (8))] is equal to “8”, which exceeds “7”, the second equation described above is also satisfied. Thus, it is recognized that the basic data stream 7 is included in the audio data stream 2.

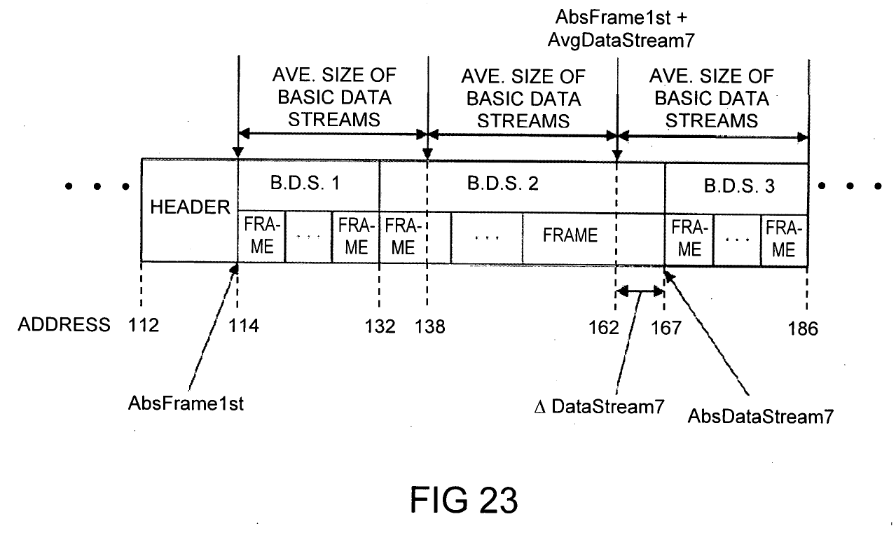

FIG. 23 is a block diagram showing a detail structure of an audio data stream 2 in which the basic data stream 7 is included. In FIG. 23, the head-location of the frame 1 of the audio data stream 2 is expressed with AbsFrame1st, the logical location of the basic data stream 7 is expressed with AvgDataStream7, the location subtraction data corresponding to the basic data stream 7 is [symbol] DataStream7, and the location of the basic data stream 7 is expressed with AbsDataStream7.

Next, an average basic data stream size AvgDataStream of the basic data streams included in the audio data stream 2 is calculated. According to the information table shown in FIG. 22, the stream size (STREAM SIZE), the sum of the frames (SUM OF FRAMES) and the number of the frames (FRAMES) of the audio data stream 2 are “72”, “24” and “8”, respectively. Thus, the average basic data stream size AvgDataStream is “24”, which is calculated by “(STREAM SIZE (72)/SUM OF FRAMES (24))×FRAMES (8)”. After the average basic data stream size AvgDataStream is calculated, the logical location of the basic data stream 7 is calculated as follows. Since the initial data stream number (INITIAL D.S.N.) of the audio data stream 2 is “5”, the logical location of the basic data stream 7 is “48”, which is calculated by “(7−5)×24”.

Then, the location finder 33 accesses the information table shown in FIG. 22 to read out the location of the location subtraction data (LOCATION of L.S.D.) of the audio data stream 2. Based on the read-out location, the location finder 33 accesses the location table shown in FIG. 21 to read out the location subtraction data of the basic data stream 7, which is located at [symbol] DataStream3 of the audio data stream 2 in FIG. 16. Furthermore, the location finder 33 also accesses the information table shown in FIG. 22 to read out the head location of the frame 1 in the audio data stream 2. Since the location subtraction data of the basic data stream 7 is “5” and the head location of the frame 1 in the audio data stream 2 is “114”, the location of the basic data stream 7 is “167”, which is calculated by “114+48+5”.

After the location finder 33 calculates the location to be replayed, the instruction circuit 2 sends the processor 1 an instruction for skipping the sample compressed audio file to the calculated location, and for replaying the sample compressed audio file from the calculated location. The processor 1 skips the sample compressed audio file to the calculated location, and replays the sample compressed audio file from the calculated location, in response to the instruction from the instruction circuit 2.

According to the audio player of the third embodiment, since the location subtraction data corresponding to each basic data stream are stored, the location of the desired basic data stream can be calculated. Thus, the compressed audio file in any compressed format can be replayed at any designated locations. As described above, since the average audio data stream size is calculated in each audio data streams, each of which includes information of the audio data to be replayed, the average audio data stream size does not increase in the case that a large amount of no audio information is included in the compressed audio file. Moreover, the location subtraction data indicates a difference between the location of the basic data stream and the logical location, which is integration of the average audio data stream size and basic data stream number. Thus, the size of the location subtraction data does not increase in the case that a large amount of no audio information is included in the compressed audio file.

Moreover, the invention can also be applied to the ADTS format of the ACC or MP3 as well as the ADIF of the ACC, and can be applied any compressed data having a frame structure. Further, the invention can also be applied to movie data as well as audio data.

As explained above, according to the audio players of the embodiments, the location of the desired basic data stream can be calculated by storing the location subtraction data corresponding to each basic data stream. Thus, the capacity of the memory, which stores locations of the frames being required for the fast-forwarding to fast-rewinding, can be reduced.

What I claim is:

1. A compressed audio file player for replaying a compressed audio file including a plurality of basic data streams, comprising:
an instruction circuit sending an instruction of performing either a fast-forwarding or a fast-rewinding for the compressed audio file;
a data size calculator calculating an average size of the basic data streams, each of the basic data streams including at least one frame;
a computational circuit calculating a logical location of each basic data stream, each logical location being calculated by integrating a number of the basic data stream with the average basic data stream size;
a location memory storing location subtraction data, which shows a difference between the relative location and the logical location of each basic data stream; and
a location finder calculating a location of the compressed audio file to be replayed from the location subtraction data of the basic data stream to be replayed and the logical location of the basic data stream to be replayed, in response to the instruction.

2. A compressed audio file player as claimed in claim 1, wherein each basic data stream includes a plurality of frames, and a number of the frames in each basic data stream is the same.

3. A compressed audio file player as claimed in claim 1, wherein the compressed audio file includes a plurality of audio data streams, each including the sequential basic data streams and non-audio data, wherein the data size calculator calculates an average size of the sequential basic data streams of a certain audio data stream, wherein the computational circuit calculates a logical location of each basic data stream in the audio data stream, each logical location being calculated by integrating a number of the basic data stream in the audio data stream with the average size of the sequential basic data streams of the audio data stream, and wherein the location memory stores the location subtraction data of every audio data stream.

4. A compressed audio file player for replaying a compressed audio file including a plurality of audio data streams each having basic data streams, comprising:
an instruction circuit sending an instruction of performing either a fast-forwarding or a fast-rewinding for the compressed audio file;
a data size calculator calculating an average size of the basic data streams included in a certain audio data stream in which a basic data stream to be replayed, each of the basic data streams including at least one frame;
a computational circuit calculating a logical location of each basic data stream, each logical location being calculated by integrating a number of the basic data stream in the audio data stream with the average basic data stream size of the audio data stream;
a location memory including a location table and a information table, the location table storing location subtraction data, which shows a difference between the relative location and the logical location of each basic data stream in the audio data streams, and the information table storing sum of the frames in the audio data stream, a relative location of the head of the basic data stream of the audio data stream, a number of the frames in each basic data stream of the audio data stream, an initial basic data stream number counted from the head of the basic data stream, which is located at head of the compressed audio file, a stream size of the audio data stream and a location data showing a location of a particular location subtraction data in the location table;
a location finder searching the audio data stream in which the basic data stream to be replayed is included, and calculating a location of the compressed audio file to be replayed from the location subtraction data of the basic data stream to be replayed, the logical location of the basic data stream to be replayed and the initial basic data stream number, in response to the instruction.

5. A compressed audio file player as claimed in claim 1, wherein non-audio data are inserted between the audio data streams.
